(19) United States
(12) Patent Application Publication
(10) Pub. No.: US 2024/0078525 A1
(43) Pub. Date: Mar. 7, 2024

(54) SYSTEM AND METHOD FOR FACILITATING CREDITOR AND CONSUMER TRANSACTIONS

(71) Applicant: H2H Technologies, Las Vegas, NV (US)

(72) Inventors: Donna Ann WEAVER, Woodland, CA (US); Prateek GUPTA, Kolkata (IN)

(73) Assignee: H2H Technologies, Las Vegas, NV (US)

(21) Appl. No.: 18/483,556

(22) Filed: Oct. 10, 2023

Related U.S. Application Data
(63) Continuation-in-part of application No. 17/544,619, filed on Dec. 7, 2021.
(60) Provisional application No. 63/227,596, filed on Jul. 30, 2021.

(51) Int. Cl. G06Q 20/10; G06Q 20/06; G06Q 20/36; G06Q 20/38; G06Q 40/03

(52) U.S. Cl. CPC G06Q 20/102; G06Q 20/0655; G06Q 20/3678; G06Q 20/389; G06Q 40/03

(57) ABSTRACT

A method, system, apparatus, and computer program product for accessing and communicating data between accounts, including incentives for their use. Consumers, businesses, creditors, and agencies may be allowed to create and manage a centralized collections account. Consumers may be able to pay, negotiate, and manage their past due debt accounts within the centralized collections account. Businesses, creditors, and agencies may be able to negotiate with customers, manage clients and sub clients, and set legal terms and conditions within the centralized collections account. Rewards may be earned for negotiating and paying off a collections account or assisting others in these actions. Businesses, creditors, and agencies may be able to electronically communicate amongst themselves and with consumers, potentially reducing postal and telephone expenses.

### CROSS-REFERENCE TO RELATED APPLICATIONS

The present application is a continuation-in-part of U.S. application Ser. No. 17/544,619, filed on Dec. 7, 2021, which claims priority to U.S. Provisional Application No. 63/227,596, filed Jul. 30, 2021, and entitled “SYSTEM FOR A GLOBAL BILL PAY NETWORK APPLICATION”, the contents of which are herein incorporated by reference in their entirety.

### BACKGROUND

Consumer debt is at an all-time high and due to the speed and ease of borrowing on our mobile phones (think buy now pay later) and expected to double or triple over the next 20 years. In the US, consumer debt is now over $17 T and globally $360 T. This is not the problem. The problem is, because of outdated consumer billing processes and a lack of personalized digital servicing to accommodate consumers when they can't make their minimum payment or afford to pay the full balance, over 77 M Americans have at least one account in collections, and are at risk of having their bank accounts levied or wages garnished. It's important to note that while the federal government positions the CFPB to help the people, they are one of the biggest culprits of wage garnishments and can both garnish and take a consumer's tax refund without notice if they are delinquent on their student loan. Additionally, the federal government allows third party collection agencies to impose extreme interest penalties on the consumer account, making it almost impossible for the consumer to resolve or return to good standing. There is no collection agency or practice that is scalable across the tens of millions of consumers with a delinquent account in collections and creditor centric software cannot accommodate the mobile Tik Tok pace and world in which we spend our time and now live in. Solutions in the marketplace provide debt counseling, lending, or collections; not a mobile, scalable, digital, fast, easy, friendly, and safe place for consumers to get out of collections. In today's world we can create our profile account on social media networks by going to the URL and creating our profile.

The number of consumers sent to collections is growing every single day and expected to skyrocket as the 330 M Snapchat consumers start transacting (they have no clue to check a mailbox or answer a call). Millennials, for example, have the highest number of accounts in collections, 4, and suffering from plunging credit scores, wage garnishments taking 20-25% of each paycheck, bank levies taking all funds from checking, savings and money market accounts and an excessive cost of money to borrow money for the basics. Millennials surveyed feel they will never get out from under the rock of debt. It is reported that debt is becoming the number 1 cause of stress, sickness, and suicides.

Additionally, when a consumer account is delinquent or charged off, not even the creditor customer support has access to tell the consumer where the account is placed. To compound this lack of visibility, creditors typically use an agency waterfall whereas every 3 months- to 1 year, they move the account to a new collection agency if not resolved. This results in the same account being reported by multiple collection agencies to the credit reporting bureaus. If none of the agencies can collect the debt, many creditors sell the account to a debt buyer and the debt buyer reports to the credit bureau and starts the collection waterfall again, often with the same agencies and repeat reporting to the credit bureaus making it impossible for the consumer to figure out how to stop being chased and the risk of wage garnishment and bank levies.

### SUMMARY

A method, system, apparatus, computer program, and network product that may eliminate the need for creditors and collection agencies to “chase” consumers and for consumers to gain full control to protect themselves from wage garnishments and bank levies, and manage all accounts from their own single portal account. Consumers may create their personal profile account to manage all collection and billing notices in one fast, easy, and safe place, and creditors, agencies and other billers can join to create their member profile account to upload all accounts and bills with the consumer's name, social and date of birth in one place. Consumers may be able to pay, negotiate, and manage their past due debt accounts within the centralized collections account. Businesses, creditors, and agencies may be able to negotiate with customers, manage clients and sub clients, and set legal terms and conditions within the centralized collections account. Rewards may be earned for paying, responding and helping consumers pay off their debts. Businesses, creditors, and agencies may be able to electronically communicate with consumers without needing their mobile, phone, mailing address or mobile phone, potentially reducing postal and telephone expenses.

### BRIEF DESCRIPTIONS OF THE DRAWINGS

The accompanying drawings illustrate various embodiments of systems, methods, and various other aspects of the embodiments. Any person with ordinary skills in the art will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 shows an exemplary method for facilitating creditor and consumer transactions.

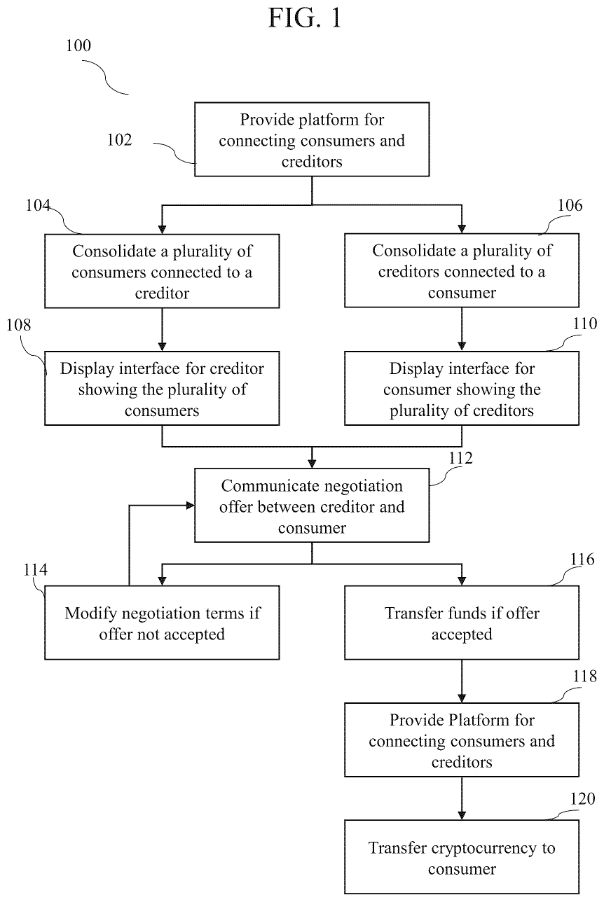

FIG. 2 shows an exemplary method for facilitating contributor and consumer transactions.

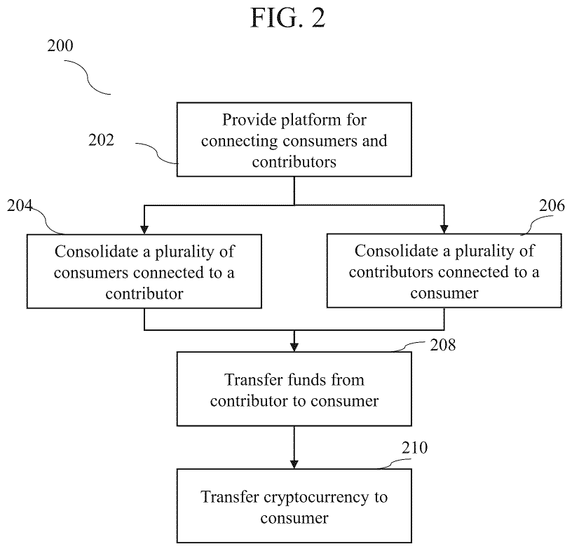

FIG. 3 shows an exemplary method for facilitating creditor and consumer transactions.

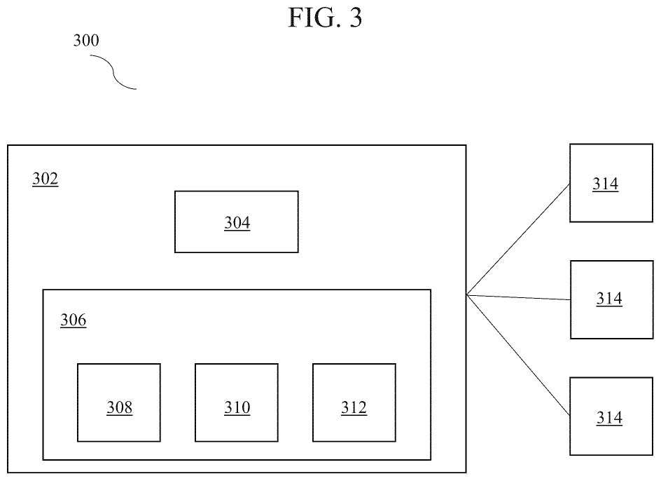

FIG. 4 shows an exemplary global bill pay network application system and its various inputs or features.

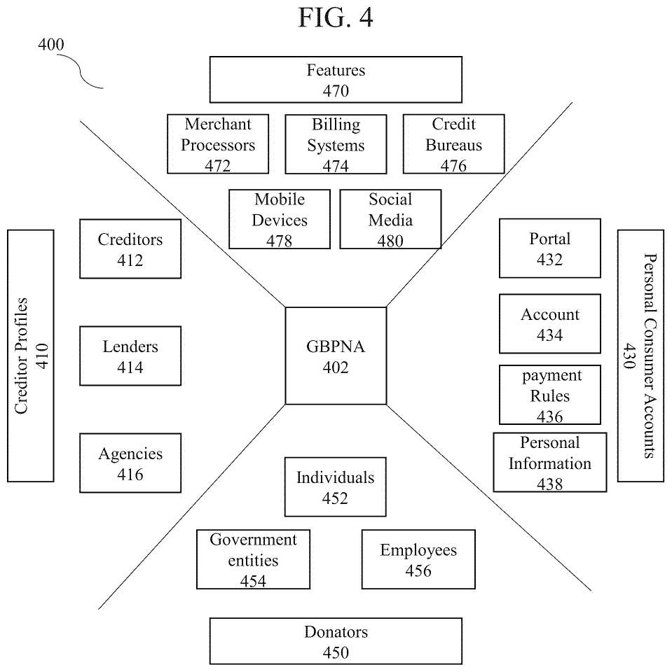

FIG. 5 shows an exemplary embodiment of a global bill pay network application as middleware.

FIG. 6 shows an exemplary creditor dashboard.

### DETAILED DESCRIPTION OF THE EMBODIMENTS

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word exemplary means serving as an example, instance or illustration. The embodiments described herein are not limiting, but rather are exemplary only. The described embodiments are not necessarily to be construed as preferred or advantageous over other embodiments. Moreover, the terms embodiments of the invention, embodiments or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

A creditor may be any business, service provider, collection agency, collection law firm or internal collection department that is extending services for credit to a consumer, servicing the loan for a creditor or service provider customer. For example, credit card, auto, and mortgage providers, hospitals, doctor offices, attorneys, utilities, etc. A consumer may be the recipient of a credit line, limit, or service. A contributor may be a donator, a person, employer, company, or professional organization that wishes to donate to directly pay some or all of a consumer bill and/or delinquent balances.

A global bill pay network application (“GBPNA”) may utilize a centralized network allowing management of collection and bill accounts for consumers, creditors, businesses, collection law firms and agencies. The centralized network may differentiate the GBPNA from software as a service (“SaaS”). For example, SaaS may require installation or implementation of software, and may require consumers to create a log in for each individual creditor and agency portal to respond and manage each account; whereas the GBPNA may not require installation or implementation of software because it may utilize a centralized network or act as a middleware for one or more billing systems for delinquent and billing accounts to flow into the GBPNA and dynamically create individual consumer portal accounts for consumers to manage all accounts from unlimited creditors. Additionally, consumers may create their personal profile account, independently from any creditor or agency portal account. Accounts may auto create a consumer portal account matching name, social and date of birth. For example, consumers can go to one URL to enter their full name, date of birth and social security number to access and set up their centralized profile account. Consumers, creditors, agencies, and businesses may be able to connect to the GBPNA in real time.

The GBPNA may also be a single application compatible with multiple languages and multiple currencies. The GBPNA may allow a user to centrally access and pay or report reason for not paying, some or all their collection and bill accounts and self-manage their payment plans from an account portal. Reasons for nonpayment may include, for example but not limited to, bankruptcy, military deployment, unemployment, deceased, medical emergency, etc. Further options may include, for example, requests for loan consolidation, credit counseling, or disputing an outstanding balance. Further, the GBPNA may allow for management of all payments and methods, thereby potentially avoiding disclosure of consumer payment information to creditors or third-party agencies. The GBPNA may accept some or all forms of payments from consumers for some or all delinquent and collection accounts. For example, the GBPNA may accept ACH, credit cards, Venmo, PayPal, Cash App, Apple Pay, Google Pay and/or cryptocurrency. The GBPNA may utilize, for example, Web 3.0 to accept, process, and reward digital and cash currency to consumers while running the GBPNA on a centralized network. In another embodiment, the GBPNA may be built with credit reporting agency requirements. This may allow the GBPNA to connect to credit bureaus to report billing and credit information and potentially increase a consumer's credit score and change the reporting and scoring formulas to help consumers honoring their accounts via alternative payment plans and terms.

It may be understood that by utilizing the GBPNA consumers may no longer need to know where their delinquent accounts are placed, no longer need to manage individual log ins for each creditor URL and portal, and no longer need their account number to access their accounts. For example, they may need not know which specific credit card, bank, store, etc. the account is associated with. The GBPNA may allow consumers to create an account using their name, social and/or date of birth to create a centralized profile account (for example a Facebook™ profile) to control how they receive reminders and communications across all creditors and agencies, a donation profile to receive donations used to directly pay any of their creditor or agency, view and respond to all collection agency, creditor, and business offers and notices. In an embodiment the GBPNA may be CRA certified, which may allow it to be connected to credit bureaus, so that consumers will be able to see all their collection or bill accounts without needing to contact creditors or agencies individually. This may result in consumers needing only to enter their name, social and/or date of birth to access all their billing and collection accounts. Also, consumers' credit scores may be boosted because in an embodiment the GBPNA may be set up to report both CRA and non-CRA accounts to credit bureaus. Consumers may also set up a permissible purpose profile within their account to receive all notices and communications digitally from collection agencies or banks through, for example, an ecoMailbox. Consumers may be able to use their account to set up a centralized communication and donation profile, upload bill pay wallets and set up other preferred payment methods. Consumers may be able to pay, negotiate, and send negotiation offers to creditors or third-party agencies, centrally or digitally. Further, consumers may now be able to self-manage their payment plans to change a payment date(s), skip a payment, cancel a payment, change the payment method and/or renegotiate the terms of a past due debt account or bill within the GBPNA. Also, unlike traditional collections, the consumer may be protected from accumulating additional interest on their account balances, failed payments may not result in the plan being cancelled out helping the consumer restart payments when they're able, and their payment methods may never be shared with any creditor or agency to eliminate risk of bank account levies and wage garnishments. Plans will stay in place so a consumer may continue with payments when their circumstances change.

Discussing now a Consumer Profile Account. A consumer may create a personal profile account on The GBPNA using their full name, social security number and date of birth (for example a Facebook™ or LinkedIn™ profile), which may be independent of, and not associated in any way to any creditor or agency website and/or GBPNA creditor profile. The consumer may have the option to create, for example, a Communication Profile, a Donation Profile, and/or a Bill Wallet in their GBPNA portal account matching their full name, social security number and date of birth as part of their master profile account.

Discussing now a Consumer Communication Profile. Consumers may create and manage their centralized and dynamic communication controls and preferences from within their portal account by choosing from text, and/or email, and/or phone, and/or mail. Consumers may also be able to choose a time period of the day and time zone to receive notifications and reminders from within their personal portal account to help them designate set times to manage their bills and collection accounts. If a consumer creates a communication profile, the GBPNA will adhere to the rules across all bill pay reminders and notifications. The GBPNA adheres to each consumer's personal rules on behalf of all creditors and collection agencies to reduce their expense and compliance risks of managing individual consumer communication rules and permissions. Additionally, the GBPNA will report any consumer opt outs directly to the do not call registry on behalf of the consumer and creditor. It may be understood that the universal communication profile may be created even before and independent from the creditor uploading accounts or offers matching the consumer's name, social and/or date of birth.

Discussing now a Consumer Donation Profile. In some embodiments Consumers may be able to add/create a donation profile in their GBPNA profile account, which may allow for any person, employee, company, government entity, and/or other entity to donate directly to pay any bill in any status (current, paste due, etc). The consumer may create their donation profile to also include their geographic area, age, gender, sexual orientation, demographic, employer, college, etc. The consumer may also be able to provide additional context or information to the profile and/or individual bills or debts, for example explaining unpaid medical debt or uploading pictures or other media to support their explanations. The GBPNA may generate a QR code for consumers to send to donators to make bill pay donations. Donators may be able to create a group to donate to pay bills. All donations may be paid directly to the bill matching the consumer's name, social, DOB and/or account number, on the consumer's behalf. It may be understood that the universal donation profile may be created even before and independent from the creditor uploading accounts or offers matching the consumer's name, social and/or date of birth.

Discussing now a Bill Pay Wallet. The consumer may choose to connect their existing Bill Pay Wallet and/or may enter individual pay methods, such as a debit card, credit card, or cryptocurrency account and/or their bank account information for ACH payments in their GBPNA profile account. Their wallet may be used to make payments to creditors and agencies and may never be shared with any creditor or agency (for example, when paying using an online wallet; payment data not shared with sellers when a consumer makes a purchase) to protect them from bank levies or having to close the account if unable to make payments. It may be understood that the universal bill pay wallet may be created even before and independent from the creditor uploading accounts or offers matching the consumer's name, social and/or date of birth.

Discussing now Consumers Responding to Written Notices. Consumers may respond to any written billing notice sent by a creditor or agency matching their full name, social security number and date of birth from within their GBPNA profile account. Responses may include uploading a photo of the written notice, entering key information on the written notice, including name, account number contact address, phone, and email. The consumer may be able to choose a payment method (in their Bill Pay Wallet or add a payment method) to pay the balance, create a discounted one-time payment or a payment plan offer or report reason why not paying, such as dispute, bankruptcy, military leave, hospitalized. If the creditor or agency has a member profile on the GBPNA, the GBPNA may automatically submit payments to their merchant processor for immediate payment; may deliver the consumer offer or reason not paying directly into the individual creditor/agency member account. If the creditor/agency is not yet a member on the GBPNA, GBPNA may send an email with a link to view their consumer customer's response with an invitation link to create a profile member account to receive the response or payment. If the notice does not include an email address, the GBPNA team may perform a Google search to locate their company website matching the sender's full company name and address to find the company email address. In the event the company email address is not located on the website, the GBPNA team may call by phone to obtain the email contact.

Consumer Responding to Creditor and Agency Offers. Consumers may (1) choose to make a one-time payoff payment using a method in their bill pay wallet or adding a payment method. GBPNA may process payments through the creditor's individual merchant processor and the merchant processor will deposit the payment directly into the creditor's bank account. GBPNA may update the balance in the consumer and creditor portal accounts. (2) choose the payment plan offer, add their payment method and starting date. GBPNA may set up the payment plan in the consumer portal account so that the consumer may self-manage their payment plan from within their GBPNA portal account (3) create and send a one-time payment or payment plan offer. GBPNA may validate the consumer offer to the offer rules in the individual creditor member account and auto approve if within parameters or deliver into the individual creditor member portal account in the Consumer Offers folder if it requires manual review. (4) report they do not owe or want to pay the bill with the reason why. GBPNA may send the no pay status and reason to the individual creditor portal account and show a status of No Pay in the consumer portal account so that the consumer no longer receives notices or reminders from the creditor specific account number. Additionally, GBPNA may report the status to the credit bureaus on behalf of the consumer and creditor.

Creditor and Agency Members Sending Offers to Consumers. Creditors and agencies may join GBPNA to create a portal account to centrally upload all consumer customer accounts in scope including (minimum data fields) consumer's full name, social security number, date of birth, balance, account number, email address or mobile phone number, and create onetime payment and payment plan offers for each consumer account. The GBPNA may match each account to a consumer's full name, social security number and/or date of birth to deliver it electronically into each consumer's profile account. If the consumer does not have a personal portal account on the GBPNA, GBPNA may automatically create a consumer portal account matching the account full name, social security number and/or date of birth, and may email or text a personal account access link or QR code. The consumer may click the link, enter their full name, social security, and date of birth to confirm a match. If this information matches the account, the consumer can view and respond to their offers from within their personal portal account, and optionally set up their communication and/or donation profile and/or bill pay wallet. Ongoing, all consumers may have access to all accounts, profiles, and activities in their profile account any time on the GBPNA URL by entering their name, social and date of birth and authenticating via their email or mobile. Additionally, a consumer may go to the GBPNA URL to access all offers and set up their communication, donation and bill pay wallets by entering their full name, social security number and date of birth.

Discussing now Consumer Sending Offers to Creditors. Consumers may go to the GBPNC URL to create a one-time payoff payment or payment plan offer in their GBPNC portal account by creating a profile using their full name, social security number and date of birth. GBPNA may digitally deliver the offer into the creditor's GBPNC portal account in the consumer offers section. Creditors may accept, decline, or create a counteroffer and GBPNA may notify the consumer using the approved methods in their communication profile. Consumers and creditors may send unlimited counter offers, and once both agree, the consumer may process the payment and set up payment plan in their personal portal account and the corresponding creditor can view from their individual portal account. In an embodiment consumers may be able to dynamically create a response to any written notice from a creditor. The response may include, for example but not limited to, creating a payment, creating a payment offer or payment plan offer, and/or reporting a reason for nonpayment.

In some embodiments, the consumer may be given a range or specific options from which to construct the counteroffer. The options may be determined by the GBPNA for each consumer in substantially real-time and may be based on a plurality of factors including but not limited to the consumers credit score, payment of past debts, a consumer's given reasons for non-payment, etc. In some embodiments the specific options and/or ranges given to the consumer may be determined by AI or ML.

Discussing now Consumer Self Managing Payment Plans. The GBPNA may allow the consumer to manage any or all of their payment plans based on real life circumstances. For example, to skip a payment, change a payment date on an individual payment, change recurring payment, change a payment method, reprocess failed payments, cancel and renegotiate a new plan, and/or pay more than one payment or pay the balance early. In some embodiments, skipping a payment and changing the payment date may only be performed a predetermined number of times. Additionally, the GBPNA may choose to maintain the payment plan to move failed payments to the back of the plan, so the consumer may choose to restart their payment plan when circumstances change. The alternate options interface may also provide information such as a scheduled date, a payment method, a payment amount, and an action such as change date or skip payment. Additionally, the consumer may pay the balance early, cancel the plan and send a new offer, or change their payment method.

Discussing now a Consumer Payment Calendar. To help consumers manage their payment plans to prevent failed payments, The GBPNA may provide a bill processing calendar with, for example, bill name, due date, and payment amount. The consumer may choose to view their personal bill pay calendar from within their GBPNA profile account only and receive reminders by, for example, text or email when payments are coming due, and/or the consumer may download the calendar with all bill names, payment amounts, payment dates and reminders into their personal calendars outside their GBPNA portal account. Downloaded calendar may include, for example, 5- or 7-day automated reminders to help consumers make changes to upcoming payment plan payments ahead of the due date. In response to one or more predetermined events, for example the acceptance or modification of a payment plan, the GBPNA may automatically update the calendar or time-keeping application with the relevant details, for example when a next payment is due, or the date or amount is changed by the consumer.

Discussing now a Consumer ecoMailbox. The GBPNA may also utilize a paperless ecoMailbox system which may enable a consumer to choose to receive communications digitally into an ecoMailbox within their portal account instead of physical USPS, email or phone. For example, a consumer may choose to use the paperless mailbox system and stop receiving mail or email, thereby potentially reducing postage costs, and adding an extra layer of security for creditors and enabling the consumer to instantly respond to report not paying, pay, set up a payment plan or send an offer, within seconds. Further, consumer communication may be built into the GBPNA thereby potentially avoiding communications outside of the GBPNA. The GBPNA may allow creditors to create personalized communications by demographic, age, sex, gender, age of account, sub account, payment status age of account, deadline of account for payment, expiration dates, charge off dates, and third-party new placements. The GBPNA may deliver each communication into the individual consumer profile account matching the full name, social security number and date of birth, and be the sole safe place for consumers to manage their communication preferences, and thus protect their data from being sent to a third-party agency for wage garnishments, bank levies and/or harassing the consumer.

Discussing now Consumer Rewards. The GBPNA may create a cryptocurrency, cash, and/or other reward wallet for each enrolled consumer so that any GBPNA, and any GBPNA member or nonmember may offer consumers rewards. The GBPNA may allow consumers to earn cryptocurrency, cash, and/or other rewards for responding to notices, paying their bills, negotiating payment plans, sending offers and/or honoring their payment plans. Other rewards may include, for example, cash back via Zelle, Apple Pay, bank account, retirement account and/or to pay their bills. In some embodiments awards may be automatically determined, offered, or awarded based on one or more thresholds, for example the amount of due debt paid off. The thresholds may be determined or modified using AI or ML. The consumer and donator/contributor may check their cryptocurrency rewards within their personal profile account.

Discussing now a Consumer Dashboard. A consumer may be able to view on a dashboard that may show one or more accounts linked to the consumer's name, social and date of birth and/or respond to a written notice. The consumer account dashboard may list a snapshot or overview of the consumer accounts. The consumer account dashboard may include, for example, an account number, an account name, a creditor name, a balance amount, a status of the account, and an action, such as, view offers, set up payment, view counteroffer, open account, view plan, or view last offer. Statuses of the account may inform the consumer of the status of the account, such as, for example, view offers, offer sent, offer/counteroffer received, approved, pending payment set up, successful payment, failed payment, payment plan in place, and so forth.

Discussing now Donators/Contributors. The GBPNA may allow donators (for example an individual, employers to help their employees, state or federal government and alumni to help students, sports teams, and celebrities to help fans to paying off debt by making a direct payment to a bill. For example, in an exemplary embodiment contributors may target a specific individual or create a group (for example geographic area, age, gender, sexual orientation, demographic, employer, college and/or bill type). Contributors may earn cryptocurrency, cash, and/or other rewards for assisting consumers in paying off debt. For example, a contributor may assist a consumer in paying off their debt and the contributor may earn a cryptocurrency reward. Additionally, creditors and business owners may be able to choose a date to digitally lease collection or bill accounts with bad or unrecovered debt to consumers, contributors, crowd funders, or the marketplace. This may create a win-win-win reward system wherein the creditor wins by receiving some or all the balance amount, the consumer wins by paying off debt, potentially raising their credit score, and earning rewards, and the contributor or crowd funder wins by receiving a cryptocurrency or cash back reward for assisting in paying a collection or bill account.

Discussing now embodiments related to a Creditor Profile.

Discussing now Creditors and Agencies Membership Profile. In another embodiment, the GBPNA may allow any biller, creditor, agency, service provider, etc. to join the GBPNA as a member and self-set up their profile account. The creditor profile account with the GBPNA may contain information about the creditor. The information may contain, but is not limited to, a company name, an industry type, a tax ID, a legal address, and a custom URL for the creditor, third party, or business, merchant account and bank account.

Discussing now Creditor Joining the GBPNC—Membership Profiles. The GBPNC may offer creditors to choose a membership package based on monthly membership fees and/or a percentage of payments made by consumers on the GBPNC. Members may set up their membership account creating import headers to match their existing billing systems using GBPNC any-to-any mapping tool, create and manage consumer offer terms at the master accounts level, the sub account level (division, customer or other), and/or consumer customer group levels to scale/help prevent wage garnishment and bank levy risk across millions of consumer customer accounts. In some embodiments communication may happen automatically after certain pre-determined events occur, for example the creation of a payment plan offer, a debt being cleared or paid off, other emergency communication, etc. Consumers may use their social security number or tax identification number, or any other suitable credentials, for access and authentication, responding to written and ecomail notices, and/or viewing account offers. For example, a bank may send a consumer a link to log into an account that lists the consumer's delinquent balance, onetime payment and alternative payment plans and potentially allows the consumer to report not paying reason, pay, choose a payment plan and/or send an offer to the bank. This may potentially save the bank outgoing call, USPS mail, communication compliance and collection expenses associated with millions of consumers delinquent account and prevent consumers being sent to third party collection agencies and law firms. Creditors and agencies may be able to receive and respond to digital offers from a consumer at any time from within their member profile account. Likewise, the creditor or agency may receive automatic notification from the GBPNA based on any of a plurality of pre-determined events, for example the acceptance of a payment plan offer, a payment being made, a notice that the consumer has submitted new reasons for non-payment and/or evidence to back up a new/existing reason, etc

Discussing now Creditor Importing and Exporting Accounts and “any-to-any” mapping system. In an embodiment, in their member profile account, creditors may export their files from any number of billing systems in their native layout and format by utilizing an any-to-any mapping system (“AAMS”). Accounts may be imported/exported manually, using, for example, SFTP or through an API into and out of the GBPNA. Further, the AAMS may enable the creditor to map the fields quickly and easily in the file to create any number of import header profiles to accommodate the native export formats of their existing billing systems. The AAMS may allow creditors to rename any number of additional mapping fields, push custom data into those fields in the system, and generate reports from the mapping fields. For example, a creditor may be able to rename mapping fields to add parameters for car model, loan type, etc. and generate reports from that customized mapping field data. It may be understood that creditors may no longer need to engage IT resources to map existing billing system layouts into the GBPNA and create instant connections to leverage any number of existing billing systems.

Discussing now Creditor Sub Accounts. To scale across millions of consumer accounts, the GBPNA may accommodate creditor's multiple billing systems and agency individual customers, by enabling them to create sub account codes to customize consumer payment terms and offers, the terms and conditions, the merchant processing and deposit bank account, communications, and reporting.

Discussing now Creditor Creates Payment Term Offers. Creditors may be able to establish offer terms at the master, sub account and consumer group levels to create one or more offers for the consumer to choose from. For example, a one-time payment settlement and a payment plan option to consumers: the offer plans may include, for example, a pay in full balance discount percentage for offering discounts on payments made in full, a payment plan balance discount percentage for offering discounts for setting up a payment plan with the creditor, a minimum monthly payment percentage of balance, and a maximum number of days to receive the first payment plan payment. For example, a creditor may establish that the pay in full balance discount percentage is 15%, the payment plan balance discount percentage is 10%, the minimum monthly payment percentage of balance is 20%, and the maximum number of days to receive the first payment plan payment is 30 days. The GBPNA may enable the creditors to set offer terms at the Master, Sub Account and Group levels to apply to groups of individual consumer accounts.

In some embodiments a payment plan may be automatically approved/auto created with one or more of the four negotiation terms filled in by the GBPNA based on creditor and consumer information, and/or one or more threshold conditions. For example, based on the amount of outstanding debt for the consumer, the time the debt has existed, previous attempts at paying off the debt, whether and how much other debt has been paid off by the consumer, etc.

Discussing now Creditor Creating Consumer Payment Terms and Conditions. Creditors may be able to create custom terms and conditions, manage, edit, update, or remove their legal terms and conditions associated with consumer payment plans at the master and sub account levels. The legal terms and conditions may be applied at the Master and Sub Account levels. For example, a business may create legal terms and conditions for an unlimited number of unique clients and/or internal lending divisions.

Discussing now Creditor Adding GBPNA Logo to Website. Creditor members may customize the GBPNA logo colors, for example, choosing the colors to match their existing websites. The creditor may dynamically preview and approve their colors, and once approved, The GBPNA may dynamically generate an embed code to add to their website and QR code to add to consumer communications to provide consumer's a personal account authentication link for instant access to view the account inside the consumer's profile account matching their name, social and date of birth. A customized logo creation tool may include interfaces for selecting primary, secondary, and background colors for the logo.

Discussing now creditor exports and reporting. Creditors may be able to schedule automated account exports and reporting within the GBPNA at the master and sub account levels. The export may require information such as an export type, sub account or master accounts, a frequency, a delivery type, etc. For example, a business may schedule an export of data, as a CSV file, to a particular sub account client, every night, and/or sent by email. The export reports may also assist in saving time and money because of the automation feature. Exports and reporting may be set up to send via email to one or multiple email addresses, SFTP and/or API.

Discussing now the GBPNA Communications. The GBPNA may provide creditors with the ability to create personalized communication templates and groups to create text, email and/or ecomail communication campaigns. The GBPNA may manage all consumer communication rules on behalf of the creditors and business by delivering communications based on each individual consumer's communication profile settings. The GBPNA may redirect communications based on real time updates made by the consumer in their consumer profile.

Discussing now Creating Customer Communication Groups. Creditors may be able to create communication subgroups within the GBPNA. The communication groups may require information such as the group name, and the group description. Creditors may be able to create the group by choosing the criteria such as, but not limited to, sub or master level, the customer type, the customer status, geography, balances, past due days, account status and other account descriptions. Creditors may be able to preview the communication group size, save the communication group, and save it to later attach a template they created. For example, a business may create a communication group titled, “Failed Payments” with a description of, “This group is for consumers whose payment failed,” with the customer type as “Failed Payments.” Communication campaigns may be tracked, and data as to the number of customers in the group, the total sent, delivered, and failed messages, and the balance value delivered, may be shown for each communication campaign.

Creditors may be able to create campaign templates, personalized at the consumer account level within the GBPNA. These campaign templates may include a template name, template type, such as email or SMS, and a template message. The campaign templates may be assigned to a selected group name, such as, “Not Joined Yet” “Joined but No Deal”, “Successful Payment Setup”, “Paid in Full”, and so forth. The further groups may be defined, added, or removed as desired by the creditor. There may be a template library which may include all the templates created with information such as, the template name, type, date of creation, and author. The template library may also include available actions to take, such as sending the template, opening the template, editing the template, or deleting the template.

Discussing now a Creditor Dashboard. The GBPNA may provide the dashboard for a creditor, showing aggregate information and detailed information. The aggregate information can include the total number of accounts uploaded by the creditor, the total amount of consumers connected to the creditor via the GBPNA, the total value of customer payments made during a predetermined period, and the total value of upcoming scheduled payments. The detailed information can include lists of open consumer offers and recent transactions. The list of open negotiation offers can show open offers that consumers have made to the creditor. The open negotiation offers list may include information about the negotiation offer such as, a customer name, an account number, a client name, an account balance, a loan original date, a placement date, a deadline to help date, and an action to take, such as viewing the offer. The list of recent transactions can show recently performed transactions with detailed information such as, a date and time, a customer name, an account number, a client name, a transaction type, a transaction ID, a payment mode, a transaction value amount, and a status, such as failed, submitted, settled, or in progress.

Discussing now GBPNA potential member benefits. It may be understood that by consolidating consumer information within the GBPNA creditors may avoid the need to send the consumer customer to third party collections, needing to purchase customer location data and spend time or resources finding customer phone, email, or address information and may avoid outbound calls, mail and emails time and expense. Additionally, it may be understood that creditors may utilize the GBPNA rather than need separate external consumer communication protocols and resources and eliminate compliance risks. Additionally, members can quickly and easily choose a membership plan, upload from existing billing systems by creating header any to any mapping profiles, set offer terms at the master, sub account and group levels to apply to unlimited consumer customers and enable consumer customers to respond, manage and pay in their own private and protected profile account.

Discussing now Creditor Consumer Offers. When viewing an open negotiation offer, creditors may see parameters for the creditor's offer, as well as parameters for the consumer's counteroffer. Any communications or notes submitted by the consumer with the counter offer can also be viewed. Creditors may be able to perform actions such as, for example, accept the offer, counter the offer, ask the client about the offer, contact the customer, or decline the offer. The negotiation offer may also include the above information on the open negotiation offers interface as well as notes from the consumer. Each negotiation offer may initially be based on the four main negotiation terms.

In some embodiments plurality of negotiation attempts, up to a predetermined limit, for example three attempts, may be facilitated by the GBPNA between a creditor and a consumer. If the consumer is unable to meet the requirements of the main negotiation terms, the GBPNA can provide the consumer with a final offer based on the creditor's term requirements. In some embodiments the GBPNA may automatically generate the final offer using, for example, artificial intelligence (AI) and/or Machine Learning (ML). If the consumer is unable to afford the final offer, the GBPNA may ask the consumer to send the creditor a custom offer that they can afford, along with reasons why the consumer cannot meet the terms of the prior offers. If necessary, terms may be updated “on-the-fly” and/or automatically for a particular consumer, and the adjustments may be made by AI and/or ML. In some embodiments the custom offer may be automatically accepted if they fall within pre-determined parameters. The pre-determined parameters may be set by the creditor and/or may be determined by AI or ML. The pre-determined parameters may include, but are not are not limited to, payment begins within a certain timeline, payment is finished within a certain timeline, each payment is above a threshold value or percentage, etc.

According to an exemplary embodiment, a method 100 for facilitating creditor and consumer transactions is disclosed. At step 102, a platform for connecting a plurality of consumers and a plurality of creditors may be provided. A consumer of the plurality of consumers may be connected to one or more creditors of the plurality of creditors, and a creditor of the plurality of creditors may be connected to one or more consumers of the plurality of consumers. At step 104, the one or more consumers that are connected to the creditor may be consolidated. At step 106, the one or more creditors that are connected to the consumer may be consolidated. At step 108, an interface for the creditor showing the one or more consumers that are connected to the creditor may be displayed. At step 110, an interface for the consumer showing the one or more creditors that are connected to the consumer may be displayed. At step 112, one or more negotiation offers between the creditor and the consumer may be communicated, via interfaces displayed to the creditor and the consumer. The negotiation offers may be subject to negotiation terms provided by the creditor. In other embodiments the negotiation offers may be automatically generated based on one or more thresholds, such as the amount of debt owed, how old the debt is, creditor or consumer information, etc., and/or may be generated by AI. It may be understood that in some embodiments the automatically generated offer may need to be accepted by the creditor before being sent to the consumer. At step 114, the negotiation terms may be modified if the negotiation terms are not accepted by the consumer. At step 116, a transfer of funds from the consumer to the creditor may be facilitated if the negotiation terms are accepted by the consumer and the creditor. At step 118, a notification, for example an email, SMS, or push notification, may be automatically sent to the creditor and/or one or more payment play reminders may be automatically calendared for the consumer. Furthermore, at step 120, a cryptocurrency reward may be sent to a cryptocurrency wallet of the consumer, as a reward for the transfer of funds from the consumer to the creditor.

According to another exemplary embodiment, a method 200 for facilitating contributor and consumer transactions is disclosed. At step 202, a platform for connecting a plurality of consumers and a plurality of contributors may be provided. A consumer of the plurality of consumers may be connected to one or more contributors of the plurality of contributors, and a contributor of the plurality of contributors may be connected to one or more consumers of the plurality of consumers. At step 206, an interface for the contributors showing the one or more consumers that are connected to the contributors may be displayed. At step 208, a transfer of funds from the contributor to the consumer may be facilitated, and the funds may only be further transferable from the consumer to a creditor. Furthermore, at step 210, a cryptocurrency reward may be sent to a cryptocurrency wallet of the contributor, as a reward for the transfer of funds from the contributor to the consumer.

According to another exemplary embodiment, a system 300 for facilitating creditor and consumer transactions is disclosed. The system 300 may include at least one central server 302, which may further include at least one data storage 304 for storing the GBPNA and the data utilized by the GBPNA and at least one processor 306 for executing the instructions of the GBPNA. Central server 302 may be in communication with a plurality of user terminals 314, which may be any known computing or portable electronic device that allows the GBPNA to function as described herein. The user terminals may be used by consumers, creditors, and contributors. A plurality of creditor accounts 308, consumer accounts 310, and contributor accounts 312 may be stored on data storage 304 and accessible via user terminals 314.

According to another exemplary embodiment an exemplary illustration of a GBPNA system and its various parties or features 400 may be shown. The exemplary illustration 400 may be understood in light of the proceeding descriptions and embodiments. The GBPNA may include a plurality of creditor profiles 410, personal consumer accounts 430, donators 450, and features 470. The creditor profiles 410 may include, for example but not limited to, creditors 412, lenders 414, and/or agencies 416. The personal consumer accounts 430 may include, for example but not limited to, a consumer portal 432, consumer accounts 434, payment rules 436, and consumer personal information 438. The donators 450 may include, for example but not limited to, individuals 452, government entities 454, and/or employees 456. The platform features 470 may include, for example but not limited to, merchant processors 472, billing systems 474, credit bureaus 476, mobile devices 478, and social media connections 480.

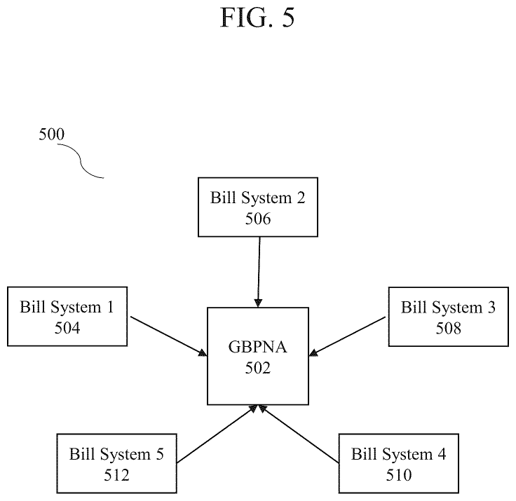

Referring to FIG. 5, an exemplary embodiment of a GBPNA as a middleware 500 may be shown and described. The GBPNA 502 may be, for example, the GBPNA described in one or more of the exemplary embodiments above. The GBPNA 502 may take in a plurality of inputs, for example bill system 1 504, bill system 2 506, bill system 3 508, bill system 4 510, and bill system 5 512. It may be understood that in other embodiments fewer or more bill systems may be used as inputs. The bill system 1 504 may store data that is incompatible with the bill system 2 506, the bill system 3 508, etc. That is to say the way data is stored in bill system 1 504 may be unreadable if fed as an input to one or more of the other bill systems. Incompatibility may further mean that if the data stored in bill system 1 504 and bill system 2 506 are both fed into a third-party software, for example excel, the data may not combine properly. In an embodiment the GBPNA 502 may take in incompatible data from bill system 1 504, bill system 2 506, bill system 3 508, etc., and may convert the data so it may be stored in a single consolidated format.

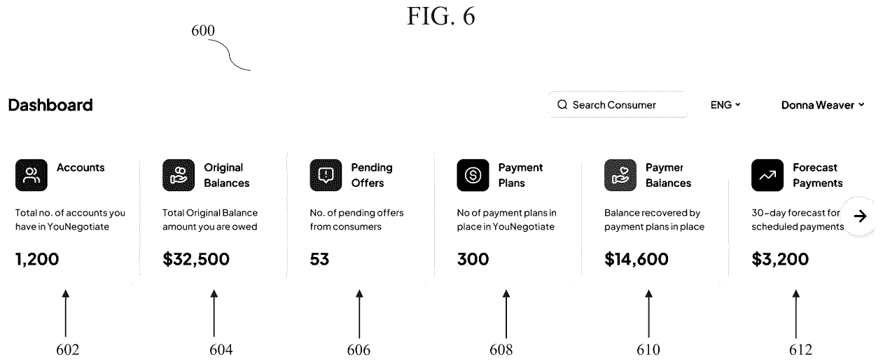

Referring to FIG. 6. An exemplary creditor dashboard 600 may be shown and described. The creditor dashboard 600 may show, for example, a number of active account 602, an original owed balance 604, number of pending offers 606, number of active payment plans 608, total balance recovered through payment plants 610, and/or forecasted payments 612.

Therefore, it may be understood that the GBPNA according to the described embodiments may be an any-to-any global rewards payment network for billing and collection accounts. Consumers may not need to know their account numbers or to know where their accounts are to make payments and manage payment plans and creditors across all industries. Furthermore, creditors and other third-party agencies such as, for example, law firms may upload accounts in any format or layout, set terms and discounts, and instantly accept traditional and non-traditional forms of payment from their customers. The GBPNA may allow creditors to generate an embed code to add the logo for the GBPNA to their website as well as a QSR code. Consumers can create their profile account with communication permissions, allowing them to quickly log in any time from a mobile application utilizing a single username and password to access all their accounts or to reply to communications to make instant payments on text and email offers. The GBPNA can further reward consumers by allowing them to earn cryptocurrency and monetary rewards every time the consumers make progress on their accounts. Furthermore, consumers can provide communication permissions for billing and collections and the GBPNA can offer a batch service to creditors to provide such data, and thereby reduce the creditors' expense of acquiring contact and location data.

The foregoing description and accompanying figures illustrate the principles, preferred embodiments, and modes of operation of those embodiments. However, the embodiments should not be construed as being limited to the embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for facilitating transactions between creditors and consumers, comprising:
providing a platform for connecting a plurality of consumers and a plurality of creditors, wherein a consumer of the plurality of consumers is connected to one or more creditors of the plurality of creditors, and a creditor of the plurality of creditors is connected to one or more consumers of the plurality of consumers;
consolidating, for the creditor, the one or more consumers that are connected to the creditor;
consolidating, for the consumer, the one or more creditors that are connected to the consumer;
displaying an interface for the creditor showing the one or more consumers that are connected to the creditor;
displaying an interface for the consumer showing the one or more creditors that are connected to the consumer;
communicating one or more negotiation offers between the creditor and the consumer, via interfaces displayed to the creditor and the consumer;
modifying the negotiation terms if the negotiation terms are not accepted by the consumer based on one or more modifications proposed by the consumer;
facilitating a transfer of funds from the consumer to the creditor if the negotiation terms are accepted by the consumer and the creditor; and
transmitting an alert in real time as one or more of an email, displayed notification, SMS message, or push notification, to one or more of the consumers and the creditor notifying that the transfer of funds from the consumer to the creditor is completed.

2. The method of claim 1, further comprising:
providing a cryptocurrency wallet for the consumer;
sending a cryptocurrency reward to the consumer upon the transfer of funds from the consumer to the creditor.

3. The method of claim 1, further comprising:
providing a platform for connecting a plurality of consumers and a plurality of contributors, wherein a consumer of the plurality of consumers is connected to one or more contributors of the plurality of contributors, and a contributor of the plurality of contributors is connected to one or more consumers of the plurality of consumers;
providing a cryptocurrency wallet for the consumer;
displaying an interface for the contributor showing the one or more consumers that are connected to the contributor;
facilitating a transfer of funds from the contributor to the consumer, wherein the funds are only further transferrable from the consumer to the creditor.

4. The method of claim 1, further comprising the platform for connecting the plurality of consumers and the plurality of creditors automatically generates the negotiation offer based on at least creditor information and debt information.

5. The method of claim 4, wherein the negotiation offer is determined using AI and/or ML.

6. The method of claim 1, further comprising automatically adjusting a calendar or other time-keeping service on at least one of a device associated with the consumer or a device associated with the creditor with details of the negotiation offer.

7. A computer program product for facilitating transactions between creditors and consumers, comprising:
a computer-usable medium having a computer-readable program code embodied therein for promoting, tracking, and assessing mental wellness, said computer readable program code adapted to execute the steps of:
providing a platform for connecting a plurality of consumers and a plurality of creditors, wherein a consumer of the plurality of consumers is connected to one or more creditors of the plurality of creditors, and a creditor of the plurality of creditors is connected to one or more consumers of the plurality of consumers;
consolidating, for the creditor, the one or more consumers that are connected to the creditor;
consolidating, for the consumer, the one or more creditors that are connected to the consumer;
displaying an interface for the creditor showing the one or more consumers that are connected to the creditor;
displaying an interface for the consumer showing the one or more creditors that are connected to the consumer;
communicating one or more negotiation offers between the creditor and the consumer, via interfaces displayed to the creditor and the consumer;
modifying the negotiation terms if the negotiation terms are not accepted by the consumer based on one or more modifications proposed by the consumer;
facilitating a transfer of funds from the consumer to the creditor if the negotiation terms are accepted by the consumer and the creditor; and
transmitting an alert in real time, as one or more of an email, displayed notification, SMS message, or push notification, to one or more of the consumers and the creditor with a notification that the transfer of funds from the consumer to the creditor is completed.
